(19) United States
(12) Patent Application Publication
(10) Pub. No.: US 2016/0350326 A1
(43) Pub. Date: Dec. 1, 2016

(54) CONCURRENCY CONTROL IN VIRTUAL FILE SYSTEM

(71) Applicant: EXTENUA, INC., Morgan Hill, CA (US)

(72) Inventor: Federico SIMONETTI, San Jose, CA (US)

(21) Appl. No.: 15/024,991

(22) PCT Filed: May 9, 2014
(86) PCT No.: PCT/US14/37579

§ 371 Date: Mar. 25, 2016

Related U.S. Application Data
(60) Provisional application No. 61/822,149, filed on May 10, 2013.

(51) Int. Cl. G06F 17/30; H04L 29/06; H04L 29/08

(52) U.S. Cl. CPC G06F 17/30168; H04L 67/1095; H04L 63/10; H04L 67/42; G06F 17/30097

(57) ABSTRACT

Methods and systems are provided for providing concurrency control over remotely- stored data that may be shared across multiple clients via virtual drives. To prevent data corruption that may result from multiple clients concurrently modifying the same file, metadata indicative of a file's locking status may be stored at the remote storage. Existence of such metadata may be checked by a client intending to access the file so that no conflicting sharing permissions may be granted to the same file by different clients. Furthermore, to prevent data corruption that may result from the synchronization of multiple offline copies of a remotely-stored file, a client may be configured to determine, before uploading its offline copy to the remote storage, whether the on line file has been modified. If so, the offline copy may be renamed with a unique name before being uploaded to avoid overwriting changes made by others.

### CROSS-REFERENCE

This application claims the benefit of U.S. Provisional Application No. 61/822,149, filed May 10, 2013, which application is incorporated herein by reference in its entirety.

### BACKGROUND

Storage virtualization techniques have allowed client applications to access remotely-stored data as if the data is stored locally. For example, a remote storage located on an online file server may be mounted onto a client computing device as a virtual disk drive. Data stored on the remote storage may thereafter be accessed by client applications running on the client computing devices as if the data exists on a local drive.

Typically, concurrency control mechanisms are implemented in non-virtual file systems to ensure data consistency and to prevent data corruption. For example, when a file stored on a local file system is opened by one user, the local operating system may “lock” or otherwise set certain file sharing permission associated with the file so that the file may appear locked or read-only to another user. Such concurrency control may be insufficient when remote storage is virtual (e.g., mounted as virtual drives) across multiple client devices. In particular, file locking mechanisms local to one client device may not be visible to another client device. Thus, multiple client devices may access the same remotely-stored files concurrently, leading to potential data corruption issues. Therefore, there is a need to enforce concurrency control in virtual file systems.

### SUMMARY

According to an aspect of the present disclosure, a computer-implemented method is provided for accessing a file stored on a remote file server. The method comprises determining, by a client device accessing the remote file server, whether concurrency control metadata associated with the file exists on the remote file server, wherein the concurrency control metadata is indicative of a sharing mode or locking status of the file. If the concurrency control metadata does not exist on the remote file server, storing the concurrency control metadata on the remote file server and opening the file on the client device in a read/write mode. If the concurrency control metadata exist on the remote file server, opening the file on the client device in a read-only mode. The client device may further remove the concurrency control metadata from the remote file server after the file is closed. The client device may access the file via a virtual drive mounted as a local drive to the client device. The concurrency control metadata may include lock file metadata, or metadata indicating that the file is locked and, for example, cannot be edited on the file server. The location path to the concurrency control metadata may encode at least in part a location path to the file.

According to another aspect of the present disclosure, a computer-implemented method is provided for synchronizing offline copies of an online file stored on a remote file server. The method comprises creating, on a client device, an offline copy of the online file stored on the remote file server. Next, with the aid of a computer processor of said client device, a first hash code of the online file is obtained at a first point in time. With the aid of a compute processor of said client device, a second hash code of the online file is obtained at a second point in time, wherein the second point in time is subsequent to the first point in time. If the first hash code is identical to the second hash code, the online file is replaced with the offline copy on the remote file server. If the first hash code is not identical to the second hash code, the offline copy is uploaded onto the remote file server with a different file name.

According to another aspect of the present disclosure, a system is provided for providing access to remote data storage. The system comprises a remote data storage programmed or otherwise configured to store data and a plurality of client computers each programmed or otherwise configured to communicate with the remote data storage via virtual drives respectively associated with the plurality of client computers, provide locking metadata associated with the data stored on the remote data storage in response to one or more requests to access the data, and determine access to the data based at least in part on whether the locking metadata associated with the data exists on the remote data storage. Data may be accessed at file-level or block-level.

Another aspect of the present disclosure provides machine-executable code that, upon execution by one or more computer processors, implements any of the methods above or elsewhere herein.

Another aspect of the present disclosure provides a system comprising a memory location comprising machine-executable code implementing any of the methods above or elsewhere herein, and a computer processor in communication with the memory location. The computer processor can execute the machine executable code to implement any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates an example environment where aspects of the present disclosure may be implemented.

FIGS. 2A-B illustrate an example scenario where data corruption may occur without the concurrency control methods described herein.

FIGS. 3A-B illustrate an example scenario where data corruption may be prevented using the concurrency control methods described herein.

FIG. 4 illustrates example components of a computer device or system for implementing aspects of the present disclosure.

FIG. 5 illustrates an example interface showing remotely-stored concurrency control metadata, in accordance with an embodiment of the present disclosure.

FIG. 6 illustrates an example process for providing concurrency control in a virtual storage system, in accordance with an embodiment of the present disclosure.

FIG. 7 illustrates an example process for providing concurrency control in a virtual storage system, in accordance with an embodiment of the present disclosure.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Methods and systems are provided for providing concurrency control over remotely-stored data that may be shared across multiple clients via virtual drives. To help prevent data corruption or version control issues that may arise from multiple clients concurrently modifying the same file, metadata indicative of the file's sharing mode or locking status may be stored at the remote storage. Existence of such metadata may be checked by a client intending to access the file so that no conflicting sharing permissions may be granted for the file by different clients. Furthermore, to prevent data corruption or version control issues that may arise from the synchronization of multiple offline copies of a remotely-stored file, each client with an offline copy of the file may be programmed or otherwise configured to determine, before uploading its offline copy to the remote storage, whether the online file has been modified. If so, the offline copy may be renamed with a unique name before being uploaded to avoid overwriting changes made by others. The determination of whether changes have occurred may be based, for example, on a comparison between hash codes of the online file that are calculated at different points in time.

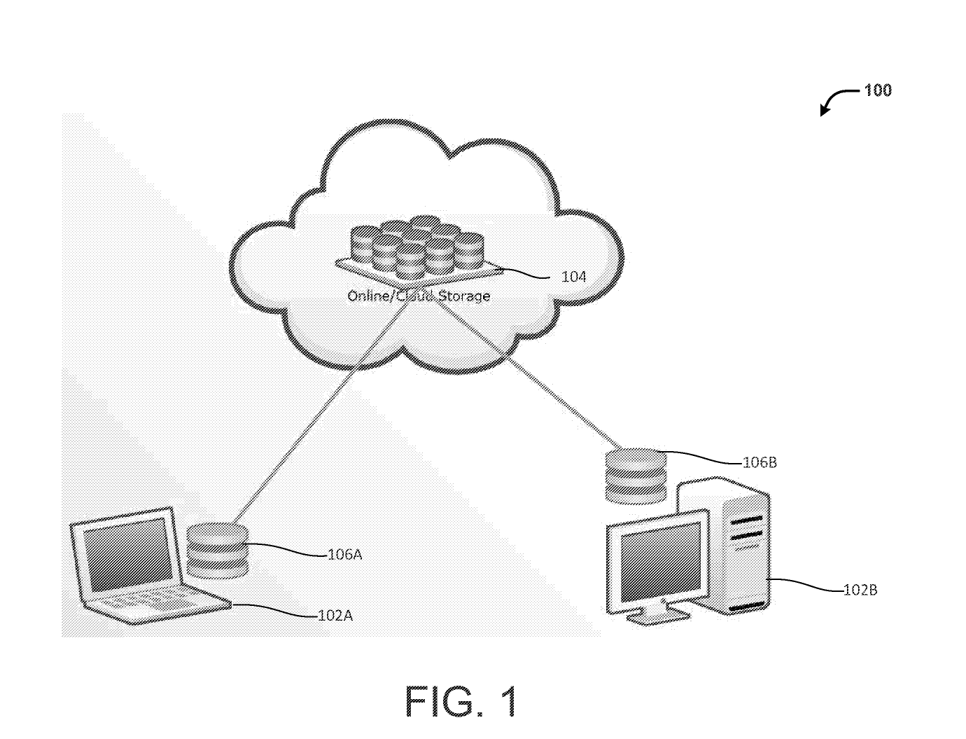

FIG. 1 illustrates an example environment 100 where aspects of the present disclosure may be implemented. As shown in the illustrated embodiment, one or more client computing systems or devices 102A-B (also “clients” herein) may be used to access data stored in a remote data storage system 104, for example, over a network. The remote data storage system 104 and client devices 102A-B may collectively implemented a virtual clustered file system where the same data stored on the remote data storage system 104 may be shared by multiple client devices, for example, via virtual storage entities (e.g., virtual drives) mounted respectively on the client devices.

In various embodiments, remote data storage system 104 may provide storage for documents, archive files, media objects (e.g., audio, video) and any other types of data. The remote data storage system 104 may include any online or cloud storage services such as S3 (provided by Amazon.com of Seattle, Wash.), Windows Azure (provided by Microsoft Corporation of Redmond, Wash.), Windows SkyDrive (provided by Microsoft Corporation), Google Drive (provided by Google, Inc. of Mountain View, Calif.), iCloud (provided by Apple, Inc. of Cupertino, Calif.), Box (provided by Box, Inc. of Los Altos, Calif.), and the like. In some embodiments, the remote data storage system 104 may be implemented by a data storage or file server, network attached storage (NAS), storage area network (SAN), or a combination of thereof. In some embodiments, the remote data storage system 104 may include one or more data storage devices or clusters thereof. Examples of data storage devices may include CD/DVD ROMs, tape drives, disk drives, solid-state drives, flash drives, and the like.

In various embodiments, clients 102A-B may include any computing devices capable of communicating with the remote data storage system 104 including desktop computers, laptop computers, tablet devices, cell phones, smart phones and other mobile or non-mobile computing devices. The clients may communicate with the data storage system over a network that may include the Internet, a local area network (LAN), wide area network (WAN), a cellular network, a wireless network or any other data network.

In various embodiments, a portion of the data stored at the remote data storage system 104 may be accessible to the clients as virtual disk drives, volume, or similar virtual storage entities 106A-B. For example, the remote data storage system 104 may be mounted as local virtual drives to the respective clients. In effect, FIG. 1 illustrates a virtual clustered storage system such as a virtual clustered file system where the same storage may be shared (e.g., mounted as virtual storage entities) across multiple clients.

In various embodiments, data stored on the remote data storage system 104 may be accessed at file level, data block level or both according to any suitable protocols. Examples of such protocols may include Network File System (NFS) and extensions thereof such as WebNFS, NFSv.4, and the like, Network Basic Input/Output System (NetBIOS), Server Message Block (SMB) or Common Internet File System (CIFS), File Transfer Protocol (FTP), Secure File Transfer Protocol (SFTP), Web Distributed Authoring and Versioning (WebDAV), Fiber Channel Protocol (FCP), Small Computer System Interface (SCSI), and the like. In some embodiments, applications running on client devices or systems treat virtual storage entities as locally storage entities such as direct attached storage (DAS). In other embodiments, the applications may communicate with the data storage system using a predefined set of application programming interface (API) supported by the remote data storage system 104.

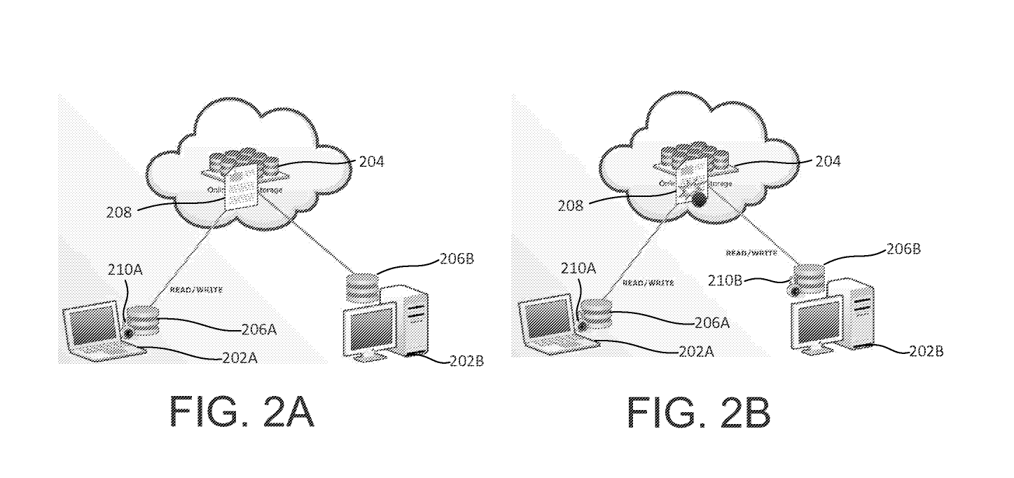

FIGS. 2A-B illustrate an example scenario where data corruption may occur without the concurrency control methods described herein. Similar to what is discussed above in connection with FIG. 1, two or more clients 202A-B may access data stored on a remote data storage system 204 via virtual local drives 206A and 206B, respectively. At any given time, such as illustrated by FIG. 2A, a processing (e.g., a user-level application) of client 202A may access (i.e., read/write) a file 208 via the virtual local drive 206A. The process may treat the virtual local drive 206A as a local drive and cause the setting a local lock or a similar indication of the file sharing mode associated with the file or data.

As used herein, a “lock” refers to a mechanism used to enforce concurrency control over a resource (e.g., a file) that is shared among multiple entities (e.g., multiple threads or processes). In various embodiments, a lock may be associated with the resources at various levels of granularity. For example, a lock may be associated with one or more data blocks, files, directories, volumes, disk drives, data storage devices, clusters of data storage devices, client devices, and the like. In some embodiment, local file locks may be maintained by local operating systems as metadata as the files are accessed by various processes. For example, in a Windows operating system, one of the following file locks or file sharing modes may be required each time a new or existing file is opened. A call CreateFile or OpenFile operating system (OS) primitive may be invoked each time a process requests the opening of a file:
0 (also known as FILE_SHARE_EXCLUSIVE): Prevents other processes from opening a file or device if they request delete, read, or write access.
FILE_SHARE_DELETE: Enables subsequent open operations on a file or device to request delete access. Otherwise, other processes cannot open the file or device if they request delete access. If this flag is not specified, but the file or device has been opened for delete access, the function fails (Note: Delete access allows both delete and rename operations).
FILE_SHARE_READ: Enables subsequent open operations on a file or device to request read access. Otherwise, other processes cannot open the file or device if they request read access. If this flag is not specified, but the file or device has been opened for read access, the function fails.
FILE_SHARE_WRITE: Enables subsequent open operations on a file or device to request write access. Otherwise, other processes cannot open the file or device if they request write access. If this flag is not specified, but the file or device has been opened for write access or has a file mapping with write access, the function fails.

Other operating systems have a similar (or identical) file sharing permission subsystem.

As illustrated in FIG. 2A, a file lock 210A set in response to a first client 202A's request to access a file 208 may be maintained by the local operating system and not known to a second client 202B. Assume that a process running on the second client 202B requests access to the same file 208 via its the virtual drive 206B while the file is still being accessed by the first client 202A. As illustrated by FIG. 2B, unaware of the local file lock 210A already issued by the first client 202A, the second client 202B may allow access to the file 208 that may not have been otherwise allowable. For example, the second client 202B may open the file in a read/write sharing mode instead of a read-only mode when the file is already opened in the read/write sharing mode by the first client 202A.

As illustrated by FIGS. 2A-B, without concurrency control for the virtual storage as described herein, two or more clients such as clients 202A-B may simultaneously access the same data (e.g., files) in a conflicting fashion, leading to potential data corruption. A similar problem may arise when offline copies of the same online file are modified by multiple clients and later synchronized. Specifically, changes made by one client may be inadvertently overwritten by another client.

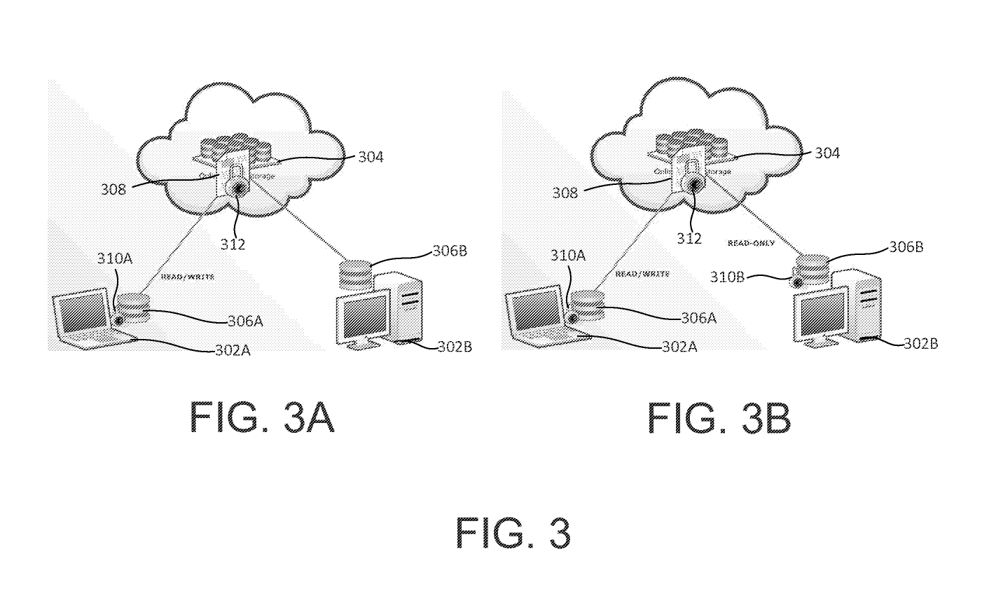

FIGS. 3A-B illustrate an example scenario where data corruption may be prevented using the concurrency control methods described herein. Similar to clients 202A-B discussed in connection with FIG. 1, clients 302A-B both have access to the a remote storage system 304 via respective virtual local drives 306A-B. At any given time, such as illustrated by FIG. 3A, a processing (e.g., a user-level application) of a first client 302A may access (i.e., read/write) a file 308 via the virtual local drive 306A, similar to the scenario illustrated by FIG. 2A. Accordingly, a local read/write file lock 310A may be associated with the file 308 such that other processes on the same client 202A may only open the file in read-only mode while the file is modified by the process. However, in this case, in addition to the local file lock, a remote file lock 312 indicative of the sharing mode or locking status of the file is also issued and stored such that other clients can learn of such sharing mode or locking status before accessing the file. In various embodiments, such a remote file lock 312 may or may not be stored on the same remote storage that stores the file 308, but the remote file lock 312 is typically stored at a location that the clients can find.

As illustrated by FIG. 3B, the second client 302B may wish to access to the file 308 at the same time the file is being access by the first client 302A. However, instead of opening the file in read/write mode as shown in FIG. 2B, the second client 302B detects the existence of the remote file lock 312 and determines that the file is currently being accessed by another client. Accordingly, the second client 302B may open the file in a read-only mode or otherwise indicates that the file is locked by another client/process subsequent to generating a local file lock 310B.

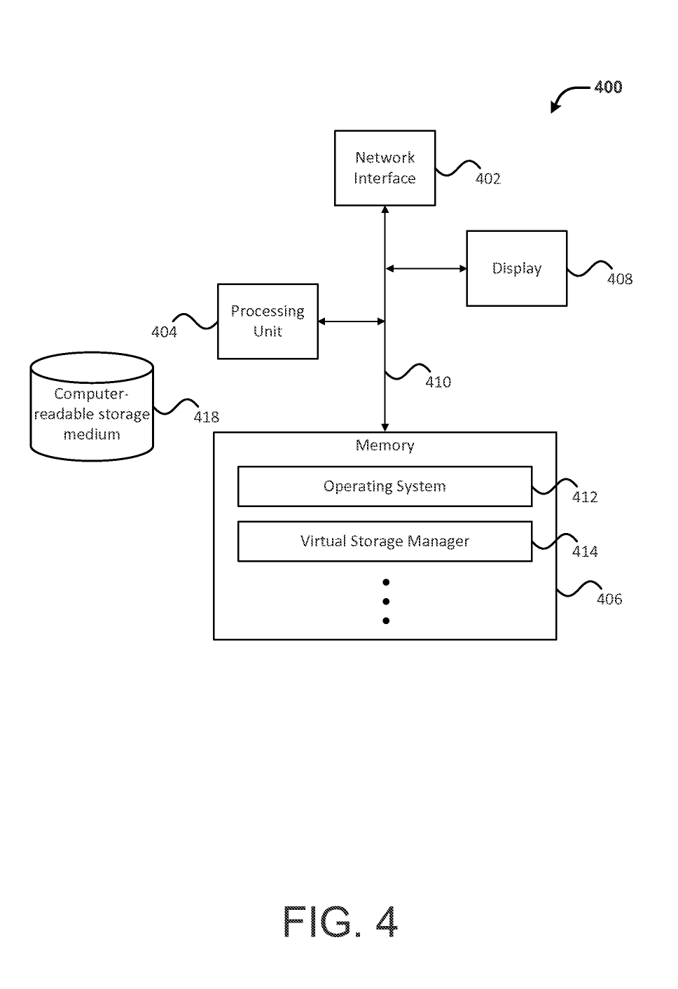

FIG. 4 illustrates example components of a computer device or system 400 for implementing aspects of the present disclosure. In an embodiment, the computer device 400 may include or may be included in the client devices or systems such as clients 102A-B illustrated in FIG. 1. In some embodiments, computing device 400 may include many more components than those shown in FIG. 4. However, it is not necessary that all of these generally conventional components be shown in order to disclose an illustrative embodiment.

As shown in FIG. 4, computing device 400 includes a network interface 402 for connecting to a network such as discussed above. In various embodiments, the computing device 400 may include one or more network interfaces 402 for communicating with one or more types of networks such as IEEE 802.11-based networks, cellular networks and the like.

In an embodiment, computing device 400 also includes one or more processing units 404, a memory 406, and a display 408, all interconnected along with the network interface 402 via a bus 410. The processing unit(s) 404 may be capable of executing one or more methods or routines stored in the memory 406. The display 408 may be configured to provide a graphical user interface to a user operating the computing device 400 for receiving user input, displaying output, and/or executing applications.

The memory 406 may generally comprise a random access memory (“RAM”), a read only memory (“ROM”), and/or a permanent mass storage device, such as a disk drive. The memory 406 may store program code for an operating system 412, a virtual drive manager routine 414, and other routines. In some embodiments, the virtual drive manager routine 414 may be configured to create and/or manage the virtual storage entities. In an embodiment, the virtual drive manager routine 414 may include or be included by a client-side component of a virtual cluster file system such as discussed in connection with FIG. 1.

In some embodiments, the software components discussed above may be loaded into memory 406 using a drive mechanism associated with a non-transient computer readable storage medium 418, such as a floppy disc, tape, DVD/CD-ROM drive, memory card, USB flash drive, solid state drive (SSD) or the like. In other embodiments, the software components may alternately be loaded via the network interface 402, rather than via a non-transient computer readable storage medium 418.

In some embodiments, the computing device 400 also communicates via bus 410 with one or more local or remote databases or data stores such as an online data storage system via the bus 410 or the network interface 402. The bus 410 may comprise a storage area network (“SAN”), a high-speed serial bus, and/or via other suitable communication technology. In some embodiments, such databases or data stores may be integrated as part of the computing device 400.

As discussed above, in some embodiments, remote file locks or similar concurrency control metadata may be used to enforce concurrency control over files or data stored on a remote storage system that may be shared as virtual storage entities across multiple clients.

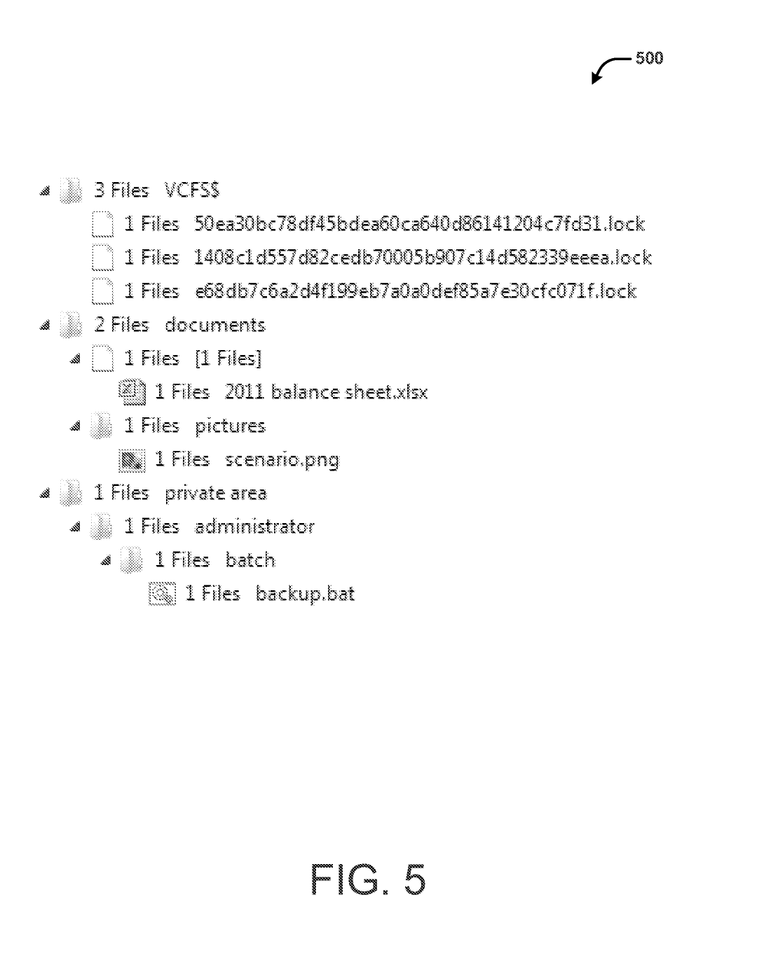

FIG. 5 illustrates an example interface 500 showing remotely-stored concurrency control metadata, in accordance with an embodiment of the present disclosure. In an embodiment, concurrency control metadata associated with a file is generated each time the file is accessed by a client. The metadata may be maintained by the same or a different storage system that stores the associated files or data. In an embodiment, such metadata may be stored in a designated location (e.g., directory) or locations that are reachable by all endpoints (e.g. client computers). For example, such metadata files may be stored in a dedicated folder in the same file server (or cloud storage) that stores the actual files or data or in one or more third-party file or cloud servers. In another embodiment, such metadata may be stored in a database such as a traditional relational database. In a preferred embodiment, the concurrency control metadata is hidden from or invisible to users of the remote storage system.

In order to maximize the speed of access to the above-discussed concurrency control metadata, it may be preferable to store all such metadata in the same directory of a file server or cloud storage. Where the number of metadata files exceeds the maximum number of files that can be stored in a single directory in a given file system, multiple directories may be used to store the metadata. To further speed up access, in some embodiments, the concurrency control metadata may be stored in a root level directory or a directory just underneath the root directory.

In the illustrated example shown in FIG. 5, three lock files corresponding to three data files that are currently being accessed are shown as stored under the “/VCFS$” directory, just below the root directory “/”. In this example, the name of each of the lock files corresponds to the non-binary form of a hash code (e.g., SHA-1 hash code) of the file name or file path of the data file to be accessed. For example, as shown in FIG. 5, the names of the lock files for the data files “/documents/2011 balance sheet.xlsx,” “/documents/2011 balance sheet.xlsx,” and “/documents/2011 balance sheet.xlsx,” may be
“50ea30bc78df45bdea6Oca640d86141204c7fd31.1ock,”
“1408c1d557d82cedb70005b907c14d582339eeea.lock” and
“e68db7c6a2d4f199eb7a0a0def85a7e30cfc071flock,” respectively. It is understood that the
illustrated encoding algorithm (SHA-1) and file extension (.lock) is provided for illustration purpose only. In various embodiments, any suitable encoding scheme and/or file extension may be used for the metadata file names. In addition, the hash code may encode a portion or all of the file name or path of the data file and/or other information such as timestamp, and the like.

In some embodiments, the content of such metadata files may also be meaningful to improve granularity of concurrency control and/or to prevent performance degradation. For example, a metadata file may store information related to the type of sharing permission requested by the original program that opened the original file. Subsequently, such information may be used by a subsequent client seeking to open the requested file to determine whether to allow, for instance, concurrent “read-only” file open operations, while denying further file open operations when there is a “write” or an “exclusive” lock on the file. This way, concurrency control may be enforced at a finer level of granularity and contention of shared resources may be reduced. In some embodiments, the metadata files may be associated with block-level access instead of file-level access. In such embodiments, the metadata files may include range of data blocks that are being locked. In other embodiments, the metadata files may store other information such as the identity of the client holding the lock, timestamp of the access, and the like.

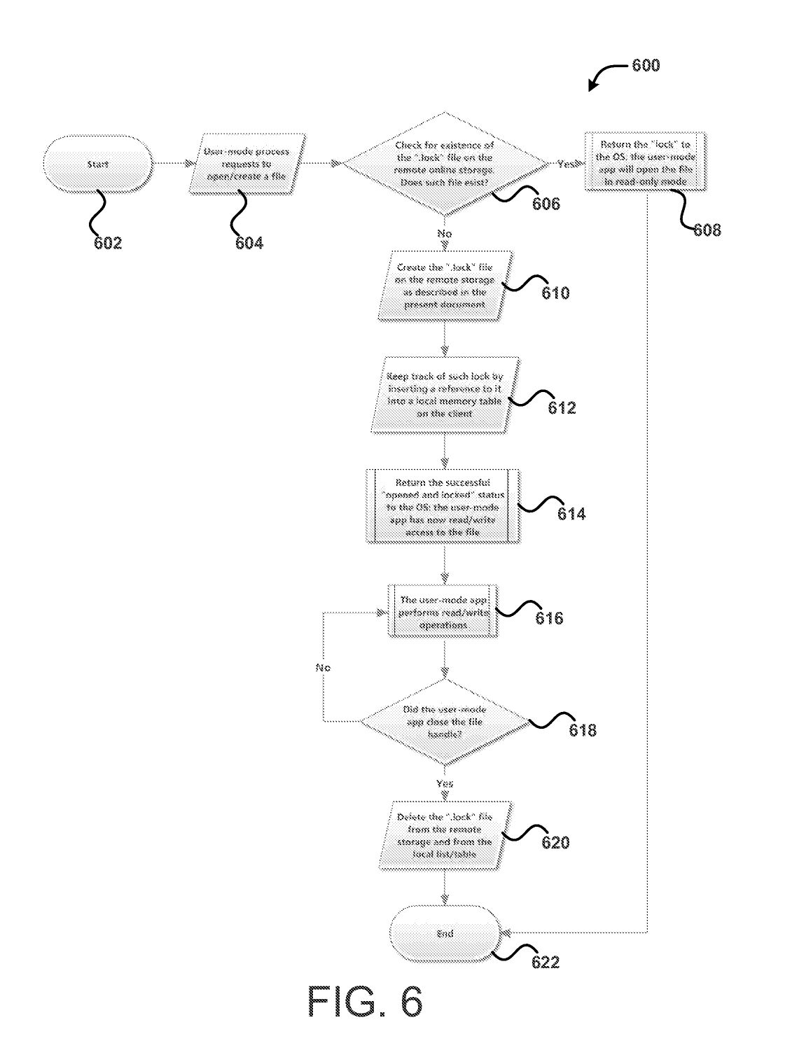

FIG. 6 illustrates an example process 600 for providing concurrency control in a virtual storage system, in accordance with an embodiment of the present disclosure. In an embodiment, process 600 may be used to handle the opening and/or closing of files in the virtual storage system to ensure data consistency.

Some or all of the process 600 (or any other processes described herein, or variations and/or combinations thereof) may be performed under the control of one or more computer/control systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. The order in which the operations are described is not intended to be construed as a limitation, and any number of the described operations may be combined in any order and/or in parallel to implement the processes. For example, process 600 may be performed by the virtual storage manager 414 of a client device 400 discussed in connection with FIG. 4.

In an embodiment, the process 600 is implemented as a user-mode asynchronous procedure or system service that makes use of an auxiliary kernel driver for the actual monitoring of file system operations. In an embodiment, the process 600 may start 602 when a user-mode process requests to open or create 604 a file in a virtual drive. The virtual drive may be used to access a portion of a remote data storage system or file system such as described in connection with FIG. 1. The virtual drive may be mounted as a local drive. From the perspective of a user-mode application, the virtual drive may be accessed in a similar fashion as any other local drives.

In an embodiment, at least a portion of process 600 may be registered as a callback routine associated with a FileCreate, FileOpen or similar operating system (OS) primitives which may be invoked upon opening and/or closing of files. When a user-mode application, such as Microsoft Word, attempts to create or open 604 a file, such an OS primitive may be passed to a kernel driver that monitors file system events. The kernel driver may then invoke the callback routine (e.g., aspects of process 600) associated with the OS primitive.

In response to the OS primitive for creating/opening a file, the process determines 606 whether concurrency control metadata exists for the file of interest. In an illustrative embodiment, determining the existence of such metadata includes checking for the existence of a “.lock” file on a remote storage system associated with the virtual drive. In some embodiments, the directory or path to the metadata files, the encoding scheme for the filenames of the metadata files, and the like may be hardcoded or configurable by system administrator or users.

If the concurrency control metadata (e.g., the “.lock” file) exists, such metadata may be provided 608 to the operating system invoking the callback routine. In some embodiments, more locking information may be provided based on the metadata file, for example, to allow finer concurrency control over the shared file or data blocks. For example, the name and/or content of the metadata file may encode identity of the holder of the lock, details of the file sharing modes, range of data blocks being locked, and timestamp of the lock and the like.

Subsequently, the operating system may pass on the locking status of the file to the original user-mode application that requested the opening or creation of the file. In some embodiments, the operating system may provide the locking information to the original user-mode application. In other embodiments, the operating system may indicate success/failure based on the locking information as well as the type of the requested access (e.g., read, write, delete). Based the operating system's information with respect to the file, the original user-mode application may handle the file accordingly. For example, if the operating system indicates that the file is currently opened in a “FILE SHARE EXCLUSIVE” or “FILE_SHARE_READ” mode and the requested access is a read operation, the user-mode application may open the file in read-only mode.

In an embodiment, if concurrency control metadata for the file does not exist, new concurrency control metadata may be created 610 for the file. For example, a “.lock” file may be created such as discussed in connection with FIG. 5. Such metadata may be stored in any suitable location that may be reachable by other clients for which the corresponding data file may be shared.

In an embodiment, the existence and/or location of such metadata files may be tracked 612 by inserting a reference the metadata files in a table or similar data structure of the client. Such a table or data structure may be stored, for example, in the memory of the client. At any given time, the client may maintain such a table or data structure to keep track of the locking information of files accessed by processes running on the client. The table or data structure may be updated, for example, as the files are created, opened, closed, deleted, or the like.

Subsequently, for example, via the callback mechanism, an indication may be provided 614 to the operating system that the file has been created/opened and locked. The operating system may relay such information to the original requesting user-mode application or process, which may proceed to open the file accordingly. For example, the user-mode application may allow the file to be opened for read/write access.

Once the file is opened, the user-mode application may perform 616 any read/write operations as necessary before the file is closed, for example, by a user. To keep the virtual file system running properly and to prevent deadlocks, the process 600 may include handling the “file close” file-system callback and deleting the lock-file from the remote storage when the file is closed by the program that originally opened and locked it.

In an embodiment, the process 600 includes determining 618 whether the file has been closed. In an embodiment, the determination may be based on a callback mechanism similar to that discussed above. For example, similar to the FileOpen or FileCreate OS primitive discussed above, a FileClose OS primitive may be provided to indicate the close of a file. Such a FileClose OS primitive may be similarly associated with a callback routine to be invoked when a file is closed. In another embodiment, the process 600 may include an asynchronous process that periodically monitors status of the file handle to determine whether it has been closed. In yet some other embodiments, a file may be forced to close upon the expiration of a predefined period.

If it is determined 618 that the data file has been closed, the process 600 includes deleting 620 the concurrency control metadata file (e.g., the “.lock”) associated with the data file from the remote storage. Reference(s) to the metadata file may also be removed from the local table or data structure storing such reference(s) such as discussed above. In various embodiments, timely removal or update of the concurrency control metadata may be required to reduce the amount of time that resources are tied up by particular processes and to avoid deadlock. The process 600 may subsequently end 622.

Variations of the embodiments discussed herein are also contemplated. For example, instead of creating and removing concurrency control metadata such as lock files in response to the opening and closing of files, the metadata may be otherwise modified or updated. For another example, while process 600 is discussed above in the context of file creation or file opening operation, a similar process may be implemented for other file operations such as file delete, file rename, and the like.

According to another aspect of the present disclosure, concurrency control is provided for the synchronization of multiple offline copies of a single file stored at a remote storage system. In some cases, clients may work on offline copies of files stored in remote storage systems. At any given time, multiple offline copies of the same file may be modified by multiple clients. When these clients go online again, such offline copies need to be synchronized correctly to ensure data consistency and/or to avoid data corruption. For example, when two clients modify offline copies of the same file, data corruption may occur if the synchronized file includes only changes from one of the clients. Thus, concurrency control mechanisms are needed to prevent one user's changes from being overwritten by another user's changes when offline copies are synchronized in a virtual file system.

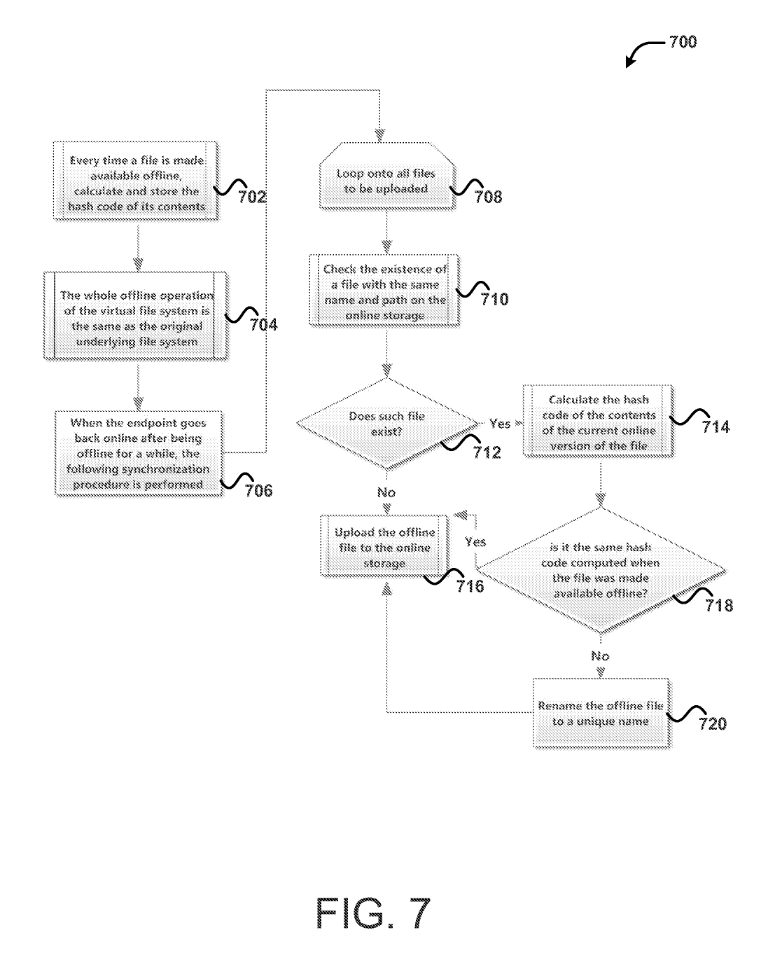

FIG. 7 illustrates an example process 700 for providing concurrency control in a virtual storage system, in accordance with an embodiment of the present disclosure. In an embodiment, process 700 may be used to handle the synchronization of multiple offline copies of a file to ensure data integrity. In an embodiment, process 700 may be performed by the virtual storage manager 414 of a client device 400 discussed in connection with FIG. 4.

In an embodiment, when an offline copy of a file of a remote storage system is made available to a client, a hash code of the file is retained by the client. Before synchronization, the hash code of the original file is compared with that of the current file stored at the remote storage. If there is no difference between the two, indicating the online file has not been changed since last time the hash code is obtained, the offline copy of the client may replace the online file as part of the synchronization process. If there are differences, indicating that the online file has been modified by another client or process, the offline copy of the client may be stored under a different name to avoid overriding changes made by another client.

In some embodiments, when a client becomes offline, copies may be made for some or all of the files available through the virtual drives of the remote storage system. Such copies may be stored locally in the client's local file system for offline edits and later synchronized with the remote storage system next time the client communicate with the remote storage system.

In an embodiment, process 700 includes determining and storing 702 a hash code of a file when it becomes available offline. Various hash functions or algorithms may be used to calculate the hash code. In other embodiments, other methods may be used for determining changes in the file. Such methods may use checksums, digital signatures or fingerprints, cryptographic functions and the like. In an example, a snapshot of the entire file may be taken. For another example, the size, modification timestamp, or other attributes of the file may be used instead of or in addition to the hash code of the file content. In various embodiments, such snapshot information (e.g., hash code) may be stored locally on the client or elsewhere.

In an embodiment, process 700 includes allowing 704 various file system operations on the offline copies the same way as for local file. In particular, the offline files may be read or modified by processes running on the client.

In an embodiment, when the endpoint (e.g., client device or system) goes back online (e.g., connected with the remote storage system), some or all of the offline copies may need to be synchronized 706. To do so, the process 700 may include iterating through 708 all the local files that need to be synchronized. In some embodiments, only files that have been modified need to be synchronized. Files that have only been read may not need to be synchronized.

For each local file to be synchronized, the process 700 may include checking 710 the existence of the corresponding online file, for example, by looking for a file with the same name and file path on the remote storage system. If it is determined 712 that such a file does not exists, then the offline copy is uploaded 716 onto the remote storage. Otherwise, it can be determined whether the current version of the file as stored at the remote storage is different than the offline copy. To that end, a hash code of the content of the current online version of the file may be calculated 714. This current hash code may be compared 718 with the previously-calculated hash code discussed in connection with block 702 of process 700. If it is determined that the hash codes are identical, then it means that this client is the first to change to online file since last time the client goes offline. Hence, the offline copy of the file can be uploaded 716 onto the remote storage to replace the current online file. Otherwise, if it is determined that the hash codes are not identical, then it means that the current online version of the file has been modified since last time the client goes offline. To avoid overwriting changes made by other clients, the offline copy may be renamed 720 to a unique name before being uploaded 716 onto the remote storage. Various renaming techniques may apply in this scenario, such as appending the user's name and/or the current timestamp to the file name. In some embodiments, more sophisticated versioning techniques may also be used. For example, in an embodiment, changes made in the offline file may be merged with the current online version of the file.

As discussed above, instead of or in addition to using comparing hash codes of file content, other methods may be used to determine whether changes have been made to the online version of the file. For example, modification timestamp, file size and the like may be compared.

This disclosure, thus, allows multiple computers to “mount” the same remote storage resource as a local virtual disk, allowing concurrent access to it while actively preventing data corruption by preventing two or more programs from opening the same file at the same time with conflicting sharing permissions.

In various embodiments, the methods described herein may apply to a file-based virtual storage system, a block-based virtual storage system or a hybrid of both. For example, instead of remote file locks, remote block locks may be used to enforce concurrency control at the block level across multiple clients. For synchronization of offline data, the hash code calculation may be performed at the block level instead of file level.

In various embodiments, the methods described herein may be implemented on the client-side, server-side or both. For example, if the remote/cloud storage that is mounted as a local virtual drive has its own file-locking or concurrency control mechanism, such mechanism may be leveraged or used by the client-side implementation.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A computer-implemented method for accessing a file stored on a remote file server, comprising:
determining, by a client device accessing the remote file server, whether concurrency control metadata associated with the file exists on the remote file server, wherein the concurrency control metadata is indicative of a sharing mode or locking status of the file;
if the concurrency control metadata does not exist on the remote file server,
storing the concurrency control metadata on the remote file server;
opening the file on the client device in a read/write mode; and
if the concurrency control metadata exists on the remote file server, opening the file on the client device in a read-only mode.

2. The computer-implemented method of claim 1, wherein the client device accesses the remote file via a virtual drive mounted as a local drive on the client device.

3. The computer-implemented method of claim 1, wherein the concurrency control metadata includes a lock file metadata.

4. The computer-implemented method of claim 1, wherein a location path to the concurrency control metadata encodes at least in part a location path to the file.

5. The computer-implemented method of claim 1, further comprising: if the concurrency control metadata does not exist on the remote file server, removing the concurrency control metadata from the remote file server after the file is closed.

6. A computer-implemented method for synchronizing offline copies of an online file stored on a remote file server, comprising:
creating, on a client device, an offline copy of the online file stored on the remote file server;
obtaining, with the aid of a computer processor of said client device, a first hash code of the online file at a first point in time;
obtaining, with the aid of a computer processor of said client device, a second hash code of the online file at a second point in time that is subsequent to said first point in time;
if the first hash code is identical to the second hash code, replacing the online file with the offline copy on the remote file server; and
if the first hash code is not identical to the second hash code, uploading the offline copy onto the remote file server with a different file name.

7. The computer-implemented method of claim 6, wherein the client device accesses the online file via a virtual drive mounted as a local drive to the client device.

8. The computer-implemented method of claim 6, wherein, if the first hash code is not identical to the second hash code, merging the offline copy with the online file.

9. A system for providing access to remote data storage, comprising:
a remote data storage configured to store data; and
a plurality of client computers each configured to:
communicate with the remote data storage via virtual drives respectively associated with the plurality of client computers;
provide locking metadata associated with the data stored on the remote data storage in response to one or more requests to access the data; and
determine access to the file based at least in part on whether the locking metadata associated with the data exists on the remote data storage.

10. The system of claim 9, wherein the data includes one or more data blocks.
